(19) United States
(12) Patent Application Publication
(10) Pub. No.: US 2013/0043221 A1
(43) Pub. Date: Feb. 21, 2013

(54) Sintering Process and Apparatus

(71) Applicants: Ryan HATHAWAY, Lynn, MA (US); Roger WILLIAMS, Acton, MA (US)

(72) Inventors: Ryan HATHAWAY, Lynn, MA (US); Roger WILLIAMS, Acton, MA (US)

(73) Assignee: XENON CORPORATION, Wilmington, MA (US)

(21) Appl. No.: 13/586,125

(22) Filed: Aug. 15, 2012

Related U.S. Application Data
(60) Provisional application No. 61/524,091, filed on Aug. 16, 2011.

(51) Int. Cl. B05D 3/06

(52) U.S. Cl. 219/76.1

(57) ABSTRACT

A two-step pulse lamp sintering process using a series of low energy light pulses to pre-treat the target before applying one or more higher energy pulses to sinter the metallic nanoparticles. The pulses can be provided so that nanoparticles are not sintered by the low energy pulse(s), but are sintered by the high energy pulse(s).

### CROSS-REFERENCE TO RELATED APPLICATION

This application claims priority from Provisional Application Ser. No. 61/524091, filed Aug. 16, 2011, which is incorporated herein by reference.

### BACKGROUND

This disclosure relates to systems and methods for sintering, and particularly, sintering metal particles.

In processing a material with fine particles, sintering is a process whereby metal particles are heated and made to cohere to one another, forming a continuous metallic film. During sintering, one or more pulses of intense light can be used to sinter nanoparticle materials. The sintering process changes the nanoparticle material from a liquid or paste state into a solid state. This process significantly increases the electrical conductivity of the material. Sintering systems and methods can require high temperatures. In the case of sintering a metal on a substrate, high temperature can damage the substrate. While a metal has a specific melting temperature, a nanometal, which is a nanometer-sized particle of a metal, can melt at a lower temperature than larger particles. A sintering system using pulsed light and/or high intensity continuous light can bind nanometals to one another and onto substrates using lower temperatures than those used with conventional sintering systems.

Sintering has broad applications, such as in the emerging field of printed electronics. Printed electronics includes printing electrically functional devices, including, but not limited to, lighting devices, batteries, super capacitors, and solar cells. Printing electronic devices can be less costly and more efficient than conventional methods for producing such devices.

### BRIEF DESCRIPTION OF THE DRAWINGS

The features and advantages of certain embodiments are illustrated in the accompanying drawings.

FIG. 1 is a schematic illustration of a system showing areas 110 of poor coating-to-substrate adhesion. FIG. 1(A) is a side view, and FIG. 1(B) is a top plan view. The substrate is represented in black, the coating is represented in gray, and the metal particle is represented by dashed lines.

FIG. 2 is a schematic illustration of a system and method showing one embodiment of the instant disclosure, using a two-stage sintering process with a conveyor transport. FIG. 2(A) is a side view, and FIG. 2(B) is a top plan view.

FIG. 3 is a graphical representation of the effect of different energy levels on a conductive ink.

### DETAILED DESCRIPTION

Conductive inks, such as those including nanometals, can be sintered with radiant energy that can include combinations of pulsed light, high intensity continuous light, ultraviolet light, radiation, and thermal energy. A UV flash lamp, for example, can be used. It provides UV radiation and thermal energy (and also includes energy in the visible range and infrared range). When the particles are sintered, they form a continuous conductive path that has a conductivity that is much higher than that of the particles before sintering.

The maker of copper nanoparticles often coat particles with an organic material to prevent oxidation prior to use. However, during the sintering process, this organic coating can act as a barrier or contaminant, resulting in incomplete sintering and areas of low conductivity within the sintered material. In the bulk state, the material is no longer a nanoparticle (i.e., it is partially or fully sintered) and thus melts at a higher temperature, and the material might not be sufficiently sintered to have the desired conductivity.

Partial sintering can occur in a variety of circumstances. Electrical circuits can be built on, for example, a polyethylene terephthalate (PET) plastic substrate. An indium tin oxide (ITO) coating can be used to create certain electrical pathways on the substrate. Additional conductive features can be built with copper (Cu) nanoparticles. The Cu nanoparticles may be applied directly onto the PET and/or on top of the ITO coating. When a high energy pulse of light is used to sinter the Cu nanoparticles, the adhesion of the ITO coating to the PET is lost in those areas that are sandwiched between the PET and the copper nanoparticles. While not being bound by any particular theory, the loss of adhesion is believed to stem from the effect of the high energy pulses on coatings of the nanoparticles. The high energy pulses sinter a top layer of the nanoparticle ink, trapping some of the coating material below the top layer. As the material heats and expands, microscopic explosions blow out through the sintered nanoparticles, causing defects and damaging the ITO and ITO/PET boundary.

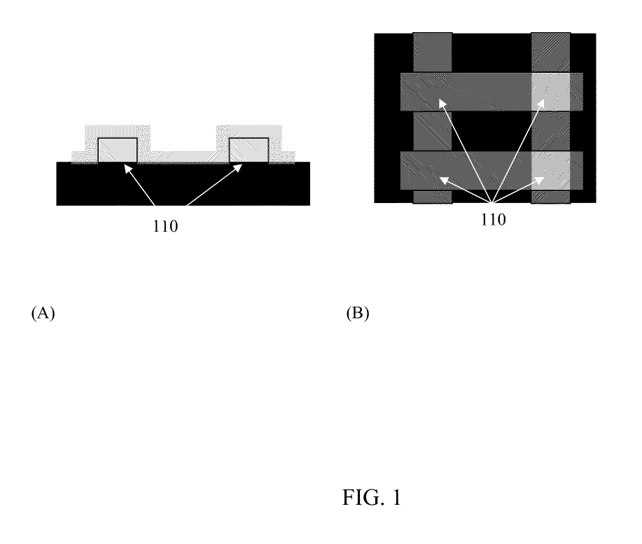

Issues that can occur with single pulse sintering process are illustrated in FIG. 1. FIG. 1A is a side view showing areas of poor coating-to-substrate adhesion, and FIG. 1B is a top plan view illustrating the same areas of poor adhesion. The coating, e.g., ITO (represented in gray), covers the substrate, e.g., PET (represented in black). The nanoparticles, e.g., copper nanoparticles (represented by dashed lines) are deposited on top of the coating and substrate. Areas 110 of poor coating-to-substrate adhesion are illustrated in FIGS. 1A and 1B.

This disclosure relates to sintering systems and methods that reduce or eliminate partial sintering. In one aspect, a two-step pulse lamp sintering uses a series of relatively low energy light pulses to pre-treat the target before applying one or more relatively higher energy pulses to sinter the metallic nanoparticles.

During the sintering process, an electronic material, such as a conductor, is added onto a substrate. The material to be sintered can be added onto the substrate using one or more technologies well known in the art, including screen-printing, inkjet printing, gravure, laser printing, inkjet printing, xerography, pad printing, painting, dip-pen, syringe, airbrush, flexography, evaporation, sputtering, etc. Various substrates can be used with the disclosed systems and methods. Substrates include but are not limited to low-temperature, low-cost substrates such as paper and polymer substrates such as poly(diallyldimethylammonium chloride (PDAA), polyacrylic acid (PAA), poly (allylamine hydrochloride) (PAH), poly(4-styrenesulfonic acid), poly(vinyl sulfate) potassium salt, 4-styrenesulfonic acid sodium salt hydrate, polystyrene sulfonate (PSS), polyethylene imine (PEI), polyethylene terephthalate (PET), polyethylene, etc.

In one aspect, a series of low energy light flashes are used to pre-treat the nanoparticle materials and associated substrate immediately prior to sintering. One advantage of the method described in this disclosure is that the low energy light pulses (under suitable conditions) can effectively remove the organic coating from the nanoparticles. The nanoparticles can subsequently be sintered with one or more pulses of radiation (light). Defects that were previously induced by the organic coating can be decreased or eliminated using the methods and systems instantly disclosed. Furthermore, the low energy light pulses effectively pre-treats the system comprising PET, ITO, and the metallic ink system. The two-step sintering process disclosed herein decreases or prevents the loss of adhesion between the substrate and the coating.

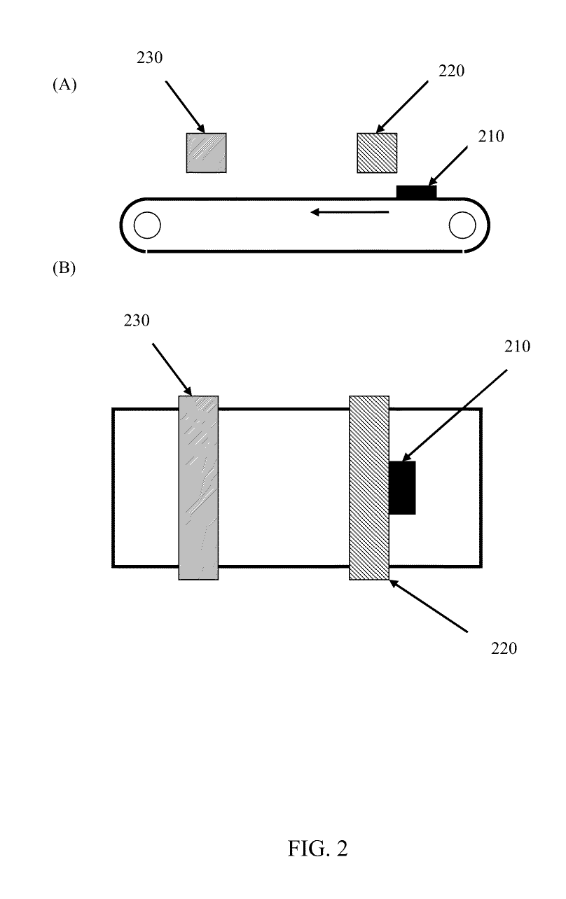

FIG. 2 is a schematic illustration of a system and method showing one embodiment of the instant disclosure. FIG. 2A is a side view, and FIG. 2B is a top plan view of a two-stage sintering process using a conveyor transport. In one embodiment, the conveyors operates at about 2.5 ft/min (or 0.8 m/min). The test sample 210 (represented in black) is placed on the sintering system, such as a conveyor system. During the first stage of the sintering process, the test sample is subjected to a series of low energy light flashes (220). The source of the radiant energy can include combinations of pulsed light, high intensity continuous light, ultraviolet light, radiation, and thermal energy. In one embodiment, a UV flash lamp is used. In one embodiment, a high-energy pulsed-light lamp system, such as the Sinteron™ 2000 (Xenon Corp.; Wilmington, Mass.), is used. In one embodiment, the series of pulses is 100 pulses per second with an energy level of about 19 Joules/pulse. The energy level used during this first stage is high enough to evaporate the coatings or contaminants on the substrate but not so high as to cause partial sintering to occur. In one embodiment, this step uses about 19 Joules/pulse (about 100 Hz), using a high voltage, such as about 3600 V. In another embodiment, this step utilizes 200 to 400 low energy pulses delivered at a pulse rate of 100 pulses per second (pps), with a preferred energy per pulse delivered to the target material 0.01 to 0.03 joules per cm² per pulse. (1-3 Watts/mm² at 100 Hz), with a total energy delivered to the material of 2 to 12 J/cm².

During the second stage of the disclosed sintering process, an energy level higher than that used in the first stage (230) is used to sinter the test sample. In one embodiment, the light pulse is about 2 pulses per second with an energy level of about 1,000 Joules/pulse. In one embodiment, a single high energy pulse is used to sinter copper nanoparticles. In another embodiment, a series of pulses are used to sinter nanoparticles. In another embodiment, the single high energy sintering flash ranges from about 400 Joules to about 2000 Joules. In another embodiment, the energy level as delivered to the material for the single high energy pulse is 1.5 J/cm² to 10 J/cm². In another embodiment, this step uses about 830 Joules per pulse (about 1.8 Hz) with a voltage of about 3800 V.

In one embodiment, the two-stage sintering process proceeds sequentially, such that the series of low energy pulses is followed immediately by the higher energy pulse. The relatively higher energy pulse can range from about 2 to about 100 times the energy of the low energy pulse, or from about 2 to 1000 times. During both stages, a variety of energy levels, pulse ranges, and pulse duration are contemplated. These ranges depend on a variety of factors, including the type of nanoparticle to be sintered and other sintering conditions. Sintering energy levels are selected such that partial sintering does not occur, and such that the nanoparticles and substrates are not damaged during the process. The lower energy pulses are sufficient to remove coatings, but not sufficient for sintering to a substantial degree. The higher energy pulse or pulses is/are capable of sintering to get a desired conductivity.

In one illustrative implementation, sintering is performed in a conveyor system, as described in U.S. patent application Ser. No. 13/188,172 entitled “Reduction of Stray Light During Sintering,” filed on Jul. 21, 2011, the contents of which are incorporated by reference in its entirety. As disclosed in the application, the application relates to systems and methods for reducing stray light during sintering, such that undesired partial sintering is reduced or eliminated. Embodiments in the application relate to systems and methods for blocking energy to a sufficient degree so as to avoid partial sintering of nanoparticles in workpieces or regions of workpieces before they are at a desired location to receive energy for sintering. In one or more embodiments, the disclosed light blockers prevent an “intermediate phase” wherein nanoparticles are only partially sintered (or not sintered) after a first exposure to light energy but do not have improved conductivity after a second exposure to light energy.

Blocking energy can have some disadvantage in that not all of the energy from the radiant energy source is utilized. However, it has been found that using the light blocker of the instant disclosure results in fully sintered nanoparticles with sufficient conductivity. The disclosed systems and methods avoid the problem of “striping” and partial sintering.

When operating on a sheet or a moving web, there is a potential issue with a phenomenon referred to here as “striping.” Striping occurs when the substrate moving towards the main energy of the radiant source, such as a pulsed lamp, has already been exposed to stray light before it reaches the point where it is to be sintered. The stray light can cause the conductive ink to be only partially sintered and converted to a bulk state. In the bulk state, the conductive ink is no longer a nanoparticle and thus melts at a higher temperature, but the material might not be sufficiently sintered to have the desired conductivity. Therefore, the pulsed light and/or high intensity continuous light at lower temperatures might not properly sinter the metal when the desired portion of the workpiece reaches the location for sintering. This issue can also arise if workpieces are near each other, e.g., on a conveyor, and a workpiece is exposed to stray light/energy before it is in an appropriate position for sintering.

The striping phenomenon can occur with various nanometals, including but not limited to copper, silver, gold, palladium, tin, tungsten, titanium, chromium, vanadium, aluminum, and alloys thereof. In some embodiments, the disclosed systems and methods prevent partial sintering of copper nanometals. At radiant energy levels lower than a first threshold range, there will be no sintering. Above that first threshold and below a second threshold, copper nanoparticles only partially sinter, but do not reach the desired level of conductivity. The conductivity of this material is higher than that of the un-sintered nanoparticles, but will not be as high as the material that receives radiant energy levels that are at a preferred range above the second threshold range. When the partially sintered material is exposed to radiant energy levels for a second time with an intensity that should be sufficient to convert the non-sintered nanoparticle to a fully conductive state, the conductivity of the previously partially sintered nanoparticles does not improve.

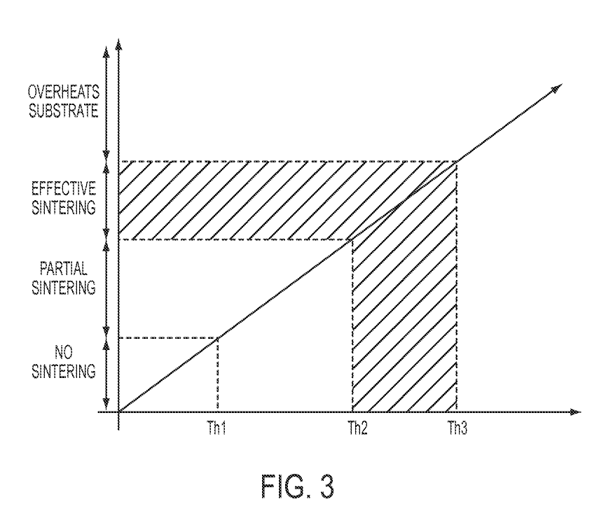

FIG. 3 graphically represents the issue in a general way. With energy below a first threshold Th1, there is no sintering. With energy above a third threshold Th3, the substrate can be damaged, at least for some substrates such as paper, polyester, and others. With energy above a second threshold Th2 and below threshold Th3, the energy is effective to increase the conductivity of the trace to a desired level. With energy between thresholds Th1 and Th2, there is only partial sintering that, at least in some materials, can help prevent full effective sintering even if the conductive ink is exposed to energy greater than Th2. This, it is desirable to be in the region bounded by Th2 and Th3, as shown shaded in FIG. 3. The thresholds can be dependent on various factors in the system and in the workpiece(s), such as the type of material to be sintered, its geometry, and the nature of the substrate.

The systems and methods to reduce stray light during sintering can include using one or more light blockers. In one or more embodiments, the light blocker is a flat mask. The mask can be positioned between the light source and a portion of the substrate to reduce or eliminate partial sintering by blocking stray light from irradiating the advancing substrate but allowing direct light exposure, such as directly under the light source, such that full sintering can occur. The mask can be on the incoming side of the conveyor, and not on the other side, or the mask can be on both sides of the conveyor direction to create an aperture. The aperture can have different shapes and sizes, including but not limited to roughly triangular, circular, oval, rectangular, etc. It is desirable for the mask to block energy that would otherwise be below threshold Th2 from reaching any workpiece or portion of the workpiece before that workpiece or portion of the workpiece is exposed to energy exceeding Th2 and thus sintering as desired.

In one embodiment, the sintering system comprises an energy source, a substrate, nanomaterial positioned on the substrate, and one or more light blockers, wherein the light blocker is positioned between the light source and the substrate, such that the light blocker blocks a sufficient amount of light energy to prevent partial sintering of the nanomaterial. In certain embodiments, if the substrate is on a conveyor, the mask can be on the incoming side of the conveyor, and not on the other side, or the mask can be on both sides of the conveyor direction to create an aperture. The aperture can have different shapes and sizes, including but not limited to roughly triangular, circular, oval, rectangular, etc. It is desirable for the mask to block energy that would otherwise be below threshold Th2 (FIG. 3) from reaching any workpiece or portion of the workpiece before that workpiece or portion of the workpiece is exposed to energy exceeding Th2 and thus sintering as desired. The nanomaterial includes but is not limited to copper, silver, gold, palladium, tin, tungsten, titanium, chromium, vanadium, aluminum, and alloys thereof. In one embodiment, the light blocker is in close contact, i.e. close proximity or distance, to the light source.

In another embodiment, the light blocker is in close contact to the substrate. In one or more embodiments, the light blocker is oriented in a vertical, horizontal, or angled direction. The proximity of the light blocker depends on various parameters of the system, including physical aperture size and shape, speed of movement, the type of radiant energy source, and the nature of the material. In some embodiments, the energy source includes a pulsed or flash lamp as the main radiant energy source.

In one embodiment, the light blocker is positioned in close proximity to the substrate but does not touch the substrate material. In one embodiment, the light blocker is positioned so that it is at least 50% of the distance from the lamp to the workpiece. In other embodiments, the mask is at least 60%, or 70%, or 80%, or 90%, or 95% of the distance from the lamp to the workpiece. The exact distance can depend on one or more parameters of the system, such as the geometry of the mask, the configuration of workpiece, speed of conveyor, and energy level.

In one or more embodiments, a movable shutter coordinates the timing of the substrate's exposure to the light source. In one or more embodiments, the substrate triggers a detector that causes a light blocker, such as in the form of a light shield, to move to a certain point until the substrate is directly below the light source.

In another aspect, one or more reflectors are used as masks that can further direct energy. Reflectors include, but are not limited to, imaging reflectors. In some embodiments, a specific portion of the reflector is removed to reduce angled light. In some embodiments, the reflector reflects light emitted from the light source toward the substrate. The reflector creates an aperture and maximizes directed energy that is applied to the substrate. The reflecting surface of the reflector can be formed at a predetermined angle to direct the light from the light source toward a position to be treated on a substrate. The position of the reflector between the substrate and the light source can be adjusted so that the intensity of the reflected light from the reflecting surface can be increased or decreased.

In one embodiment, the light source emits light in an upward direction. In another embodiment, the light source emits light in a downward direction. The direction in which the light source emits light can be determined based on the conditions and positions of the various workpieces, including the substrate and the light blocker.

The systems and methods described herein can be used alone or in conjunction with one another to reduce stray light during sintering.

The sintering systems can include a conveyor system with the substrate located directly above the conveyor. The conveyor can operate, for example, at speeds from 2 feet/min to 1000 feet/min (0.6 m/min to 300 m/min) to move the substrate. A conveyor control module can determine the speed at which the substrate is being moved. For example, the conveyor system can operate in a start/stop motion as well as in a continuous motion. The motion of the conveyor is coordinated with the flashing action to ensure that the workpiece gets a sufficient amount of energy for sintering where needed. The workpiece can include larger pieces, such that the energy can be provided to a portion at one time, and then is provided to another portion. Or, there can be a succession of different pieces, e.g., on a conveyor. The mask can allow the workpieces to be placed closer together so that the sintering to one (or a group), does not partially sinter others.

The system can include a contact shield is attached to the side of the mask that first comes into contact with the lamp. The system can include a collimating device for narrowing a beam of light and/or aligning the beam of light in a specific direction.

In another aspect, after the electronic material is added onto the substrate, but before the substrate with the electronic material reaches a light sintering station, the substrate is coated with a solution that reduces or eliminates partial sintering from stray light, but allows sintering from directed light (e.g., the light under the lamp), this serving as a light blocker for energy coming in at an angle. In one or more embodiments, the coating can be later removed during sintering by the force of the directed light and/or “washed away” with a follow-on process.

The sintering systems can include a conveyor system with the substrate located directly above the conveyor. The conveyor can operate, for example, at speeds from 2 feet/min to 1000 feet/min (0.6 m/min to 300 m/min) to move the substrate. A conveyor control module can determine the speed at which the substrate is being moved. For example, the conveyor system can operate in a start/stop motion as well as in a continuous motion. The motion of the conveyor is coordinated with the flashing action to ensure that the workpiece gets a sufficient amount of energy for sintering where needed. The workpiece can include larger pieces, such that the energy can be provided to a portion at one time, and then is provided to another portion. Or, there can be a succession of different pieces, e.g., on a conveyor.

In some embodiments, a conveyor belt system moves the substrate continuously during sintering, and thus typically coordinated in speed with the flashing frequency of the lamp; in other embodiments, the conveyor is moved in a step-wise manner. The light source could be moved, with a workpiece or number of workpieces being stationary.

In one embodiment, the sintering system comprises an energy source, a substrate, and nanomaterial positioned on the substrate. In one embodiment, only one lamp is used to as an energy source to produce both the low and high energy flashes. In another embodiment, one or more separate lamps can be used to produce the low and high energy flashes. The nanomaterial includes but is not limited to copper, silver, gold, palladium, tin, tungsten, titanium, chromium, vanadium, aluminum, and alloys thereof.

The systems and methods disclosed herein can be used alone or in conjunction with other systems for reducing partial sintering. For example, the two-step sintering process disclosed herein can be used in conjunction with systems and methods for reducing stray light during systems, such as that described in the above-referenced U.S. patent application Ser. No. 13/188,172.

In one embodiment, the system for reducing stray light is a light blocker, such as a shield. In one embodiment, the light blocker is in close contact, i.e. close proximity or distance, to the light source. In another embodiment, the light blocker is in close contact to the substrate. In one or more embodiments, the light blocker is oriented in a vertical or angled direction. The light blocker reduces partial sintering and reduces substrate destruction by ensuring that the substrate is not continually absorbing energy.

Exemplary ranges of a general flash lamp operating parameters include the following:
1. Pulse Duration: 1 [symbol] s to 100,000 [symbol] s measured at ⅓ peak value.
2. Energy per Pulse: 1 joule to 5,000 joules.
3. Pulse Rates: Single pulse to 1,000 pulses per second.
4. Pulse mode: single pulse, burst, or continuous pulsing.
5. Lamp Configuration (shape): linear, spiral, or u-shape.
6. Spectral Output: 180 nanometers to 1,000 nanometers.
7. Lamp Cooling: ambient, forced air, or water.
8. Wavelength Selection (external to the lamp): none or IR filter.
9. Uniformity Ranges±0.1% to ±25% Center to Edge
10. Lamp Housing Window: none, pyrex, quartz, suprasil, or sapphire.
11. Top and Bottom Sequencing: Any combination in between from 0% to 100% top lamp to 0% to 100% bottom lamp.

Having described embodiments of the present disclosure, it should be apparent that modifications can be made without departing from the scope of the disclosure described herein. The system can be used in conjunction with other filters. Further, the methods described here can be used with nanoparticles without coatings. The low energy pulse(s) appear to provide other beneficial effects for sintering, e.g., in the case of silver particles, pre-heating the particles and possibly also changing the surface tension can result in better sintering.

What is claimed is:

1. A method comprising:
providing at least one relatively low energy light pulse with a flash lamp to a printed electronic circuit including conductive nanoparticles; and
after providing to the printed electronic circuit one or more relatively low energy light pulses, providing one or more relatively high energy light pulse with a flash lamp to the printed electronic circuit with conductive nanoparticles to sinter the conductive nanoparticles,
wherein the energy level of the relatively high energy pulse is 2 to 1000 times the energy of each of the one or more low energy pulses.

2. The method of claim 1, wherein the relatively low energy light pulses and the relatively high energy light pulses are provided with a single lamp.

3. The method of claim 1, wherein the relatively high energy light pulses and the relatively low energy light pulses are provided with multiple lamps, including a first lamp for providing relatively low energy pulses and a different second lamp for providing relatively high energy pulses.

4. The method of claim 1 wherein providing one or more relatively high energy pulses includes providing a single high energy pulse.

5. The method of claim 1 wherein the energy level of the relatively high energy pulses is 50 to 1000 times the energy of each of the one ore more relatively low energy pulse.

6. The method of claim 1 wherein the energy level of the relatively high energy pulses is 2 to 100 times the energy of each of the relatively low energy pulse.

7. The method of claim 1 wherein providing one or more low energy pulses is at an energy insufficient to partially sinter the nanoparticles, and wherein the relatively high energy pulses are each sufficient to sinter the nanoparticles.

8. A method comprising:
providing at least one relatively low energy light pulse with a flash lamp to a printed electronic circuit including conductive nanoparticles, wherein the energy level of each pulse is not sufficient to cause partial sintering of the nanoparticles; and
after providing one or more relatively low energy light pulses, providing one or more relatively high energy light pulse with a flash lamp to the printed electronic circuit including conductive nanoparticles, wherein the high energy light pulses have sufficient energy to sinter the conductive nanoparticles.

9. The method of claim 8, wherein the relatively low energy light pulses and the relatively high energy light pulses are all provided with a single lamp.

10. The method of claim 8, wherein the light pulses are provided with multiple lamps, including a first lamp for providing relatively low energy pulses and a different second lamp for providing relatively high energy pulses.

11. The method of claim 8, wherein providing one or more relatively high energy pulses includes providing a single high energy pulse.

12. The method of claim 8, wherein the nanoparticles have an organic coating, and wherein the one or more relatively low energy pulses are provided with sufficient energy to remove the organic coating from the conductive ink without causing partial sintering.

13. The method of claim 12, wherein the substrate has a conductive coating adhering to the substrate, and wherein the removal of the organic coating from the nanomaterial preserves the adhesion between the substrate and the conductive coating.

14. A sintering system for use with a workpiece that includes a substrate with a printed conductive ink having metallic nanoparticles, comprising:
a first flash lamp configured to provide at least one relatively low energy light pulse to a workpiece;
a second flash lamp configured to provide to a workpiece one or more high energy pulses after the first flash lamp provides the at least one relatively low energy light pulse, wherein the energy level of the relatively high energy light pulse is 2 to 1000 times the energy of the low energy pulse, and wherein the relatively high energy light pulse has sufficient energy to sinter conductive nanoparticles in a printed conductive ink, and wherein the relatively low energy light pulse does not have sufficient energy to sinter conductive nanoparticles in a printed conductive ink.

15. The system of claim 14, in combination with a workpiece including a substrate having a printed conductive ink having metallic nanoparticles.

16. The system of claim 14, wherein the first flash lamp and the second flash lamp are one lamp.

17. The system of claim 14, wherein the first flash lamp and the second flash lamp are different lamps.

18. The system of claim 14, wherein each flash lamp provides pulses of energy with a pulse duration of 1 μs to 100,000 μs measured at ⅓ peak value, and 1-5000 Joules per pulse.

19. The system of claim 14, wherein the sources of energy pulses are stationary, the system further comprising a conveyor for transporting the workpiece to positions where the workpiece can receive energy from the first and second flash lamps.

20. The method of claim 8, wherein the method consists essentially of the providing steps, and wherein the providing of relatively high energy pulses immediately follows providing relatively low energy pulses.
